(19) United States
(12) Patent Application Publication
(10) Pub. No.: US 2024/0370815 A1
(43) Pub. Date: Nov. 7, 2024

(54) SYSTEM AND METHOD FOR DETERMINING AN OPTIMAL LOGISTICS PLAN FOR SHIPPING PERISHABLE GOODS

(71) Applicant: KEEPING IT COOL, INC., Miami, FL (US)

(72) Inventors: Richard MARRON, Chicago, IL (US); Walter Patrick Burke, Miami, FL (US)

(21) Appl. No.: 18/655,154

(22) Filed: May 3, 2024

Related U.S. Application Data
(60) Provisional application No. 63/500,355, filed on May 5, 2023.

(51) Int. Cl. G06Q 10/0832

(52) U.S. Cl. CPC G06Q 10/0832

(57) ABSTRACT

Disclosed herein are systems and methods for determining an amount of coolant for shipping a shipment of perishable goods. In one aspect, an exemplary method comprises, collecting thermal data from temperature sensors or temperature indicators from previous shipments, associating the thermal data with its respective shipment, collecting environmental data associated with the previous shipments, building a model of expected thermal behavior that is based both on collected data from temperature sensors or temperature indicators from the previous shipments and the collected environmental data associated with the previous shipments and predicting the amount of coolant for the shipment based on the model of the expected thermal behavior.

### CROSS-REFERENCE TO RELATED APPLICATION

This patent application claims the benefit of the filing date of U.S. Provisional patent application Ser. No. 63/500,355, filed on May 5, 2023, titled “SYSTEM AND METHOD FOR DETERMINING AN AMOUNT OF COOLANT FOR SHIPPING PERISHABLE GOODS,” the content of which is hereby expressly incorporated by reference.

### FIELD OF TECHNOLOGY

The present disclosure relates to the field of temperature control and supply chain for shipping perishable goods, e.g., food, medication, and the like.

### BACKGROUND

One of the biggest problems with shipping perishable goods is ensuring that the temperature is maintained throughout the journey of the goods from the source to the destination. For example, some goods may not remain fresh beyond a limited amount of time after an initial exposure to a temperature above freezing.

Many inter-related factors impact if the perishable goods are delivered within the desired temperature range. These include but are not limited to a source distribution center that a shipment of perishable goods is sent from, a shipping method used to deliver the shipment (ground shipping, 2-day shipping, etc.), a date the shipment is sent on, packaging used for the shipment, and coolant included within the shipment. Collectively, these factors make up a logistics plan.

The logistics plan for a particular shipment of perishable goods may require precise determination to ensure that goods arrive safely at their respective destinations while also not over-spending on aspects of the logistics plan such as the shipping method, packaging and coolant. For instance, without a system, a human operator may need to guess how much coolant is required based on the estimated number of hours that will transpire during transportation of the perishable goods, the ambient temperature of the delivery at one or more stages of the transportation journey, etc. If the estimate is inaccurate, there is a risk of spoilage to the perishable goods. Commonly, a transportation operator will deal with this issue by overestimating the amount of coolant required during transportation in order to minimize the risk of spoilage to the perishable goods. Consequently, an enterprise may incur a greater cost than required for shipping goods to various destinations.

Therefore, there is a need for increased optimization in determining a logistics plan for shipping perishable goods. Moreover, there is a need for optimizing auditing data about temperature of perishable goods maintained during shipment.

### SUMMARY

Aspects of the disclosure relate to accurate determination of a logistics plan for shipping perishable goods from a source location to a destination.

In one aspect, a method is provided for determining a logistics plan for a future shipment of perishable goods, comprising: collecting thermal data from temperature sensors or temperature indicators that was captured during previous shipments; associating the thermal data with a respective shipment; collecting environmental data associated with the previous shipments; building a model of expected thermal behavior based on the collected thermal data and the collected environmental data; and determining a logistics plan for the future shipment based on the model of expected thermal behavior.

In one aspect, the method further comprises diagnosing errors in previous shipments, and further predicting the amount of coolant based on an analysis of the diagnosed errors in the previous shipments.

In one aspect, a method of determining a logistics plan may include measuring, capturing, or generating data regarding a distribution center where a perishable good or goods should be sent from, a shipping method that should be used, a container and insulation that the perishable good or goods should be placed in, a determination of a day/date the perishable good or goods should be shipped, a type of coolant that should be included with the perishable good or goods, an amount of coolant included with the perishable good or goods during shipment or any other aspects of a logistics plan that may impact the thermal performance of a shipment of perishable goods.

According to one aspect of the disclosure, a system is provided for determining a logistics plan for shipping perishable goods, the system comprising at least one hardware processor configured to: collect thermal data from temperature sensors or temperature indicators from previous shipments, associate the thermal data with its respective shipment, collect environmental data associated with the previous shipments, build a model of expected thermal behavior that is based both on collected data from temperature sensors or temperature indicators from the previous shipments and the collected environmental data associated with the previous shipments, and develop a complete logistics plan for the shipment based on the model of the expected thermal behavior.

In one aspect, a non-transitory computer-readable medium is provided storing a set of instructions thereon for determining a logistics plan for shipping a shipment of perishable goods, wherein the set of instructions comprises instructions for: collecting thermal data from temperature sensors or temperature indicators from previous shipments, associating the thermal data with its respective shipment, collecting environmental data associated with the previous shipments, building a model of expected thermal behavior that is based both on collected data from temperature sensors or temperature indicators from the previous shipments and the collected environmental data associated with the previous shipments, and determining a logistics plan for the shipment based on the model of the expected thermal behavior.

The method and system of the present disclosure are designed to provide improvements in determining logistics plans for shipping perishable goods and reduce spoilage of goods.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a block diagram of a method for collecting data using mobile devices of shipment recipients and temperature sensors in accordance with aspects of the present disclosure.

FIG. 2 illustrates diagrams of a mobile device with instructions displays for a shipment recipient in accordance with aspects of the present disclosure.

FIG. 3 illustrates a diagram of an instruction placed on a sensor for viewing by a shipment recipient in accordance with aspects of the present disclosure.

FIG. 4 illustrates a diagram of a mobile device being held in proximity to a sensor to facilitate a reading of temperature data associated with a shipment in accordance with aspects of the present disclosure.

FIG. 5 illustrates a block diagram of a method for collecting data from postal services and temperature sensors in accordance with aspects of the present disclosure.

FIG. 6 illustrates a diagram of an envelope with a barcode for identifying a sensor in the envelope in accordance with aspects of the present disclosure.

FIG. 7 illustrates a block diagram of a method for collecting data using mobile devices of shipment recipients and chemical temperature indicators in accordance with aspects of the present disclosure.

FIG. 8 illustrates a diagram of an instruction placed on a chemical temperature indicator for viewing by a shipment recipient in accordance with aspects of the present disclosure.

FIGS. 9a and 9b illustrates a block diagram of a method for collecting thermal data from electronic temperature sensors in accordance with aspects of the present disclosure.

FIG. 10 illustrates a block diagram of a method for collecting thermal data from chemical temperature indicators in accordance with aspects of the present disclosure.

FIG. 11 illustrates a block diagram of a method of determining a logistics plan for a shipment of perishable goods in accordance with aspects of the present disclosure.

FIG. 12 presents a representative diagram of an example of various components and features of a general purpose computer system usable or incorporable with various features in accordance with aspects of the present disclosure.

FIG. 13 is a block diagram of various example system components, usable in accordance with aspects of the present disclosure.

### DETAILED DESCRIPTION

Aspects of the present disclosure are described herein in the context of a system, method, and a computer program for determining a logistics plan for shipping perishable goods. Those of ordinary skill in the art will realize that the following description is illustrative only and is not intended to be in any way limiting. Other aspects will readily suggest themselves to those skilled in the art having the benefit of the disclosure. Reference will now be made in detail to implementations of the example aspects as illustrated in the accompanying drawings. The same reference indicators will be used to the extent possible throughout the drawings and the following description to refer to the same or like items.

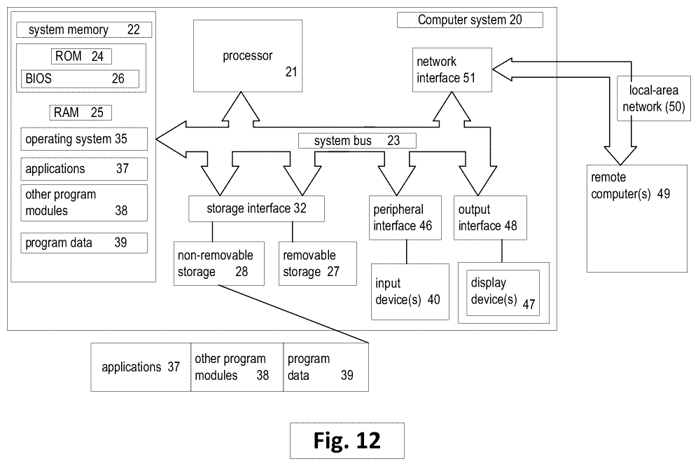

In one aspect, the present disclosure describes a system for determining an optimal logistics plan, and in some cases an optimized amount of coolant needed, for shipping perishable goods. The system is implemented on a computing system that includes real-world devices, systems, components, and groups of components realized with the use of hardware such as integrated microcircuits (application-specific integrated circuits, ASICs) or field-programmable gate arrays (FPGAs) or, for example, in the form of a combination of software and hardware such as at least one microprocessor system and set of program instructions, and/or also on neurosynaptic chips. The functionality of such means of the system may be realized solely by hardware, and also in the form of a combination, where some of the functionality of the system means is realized by software, and some by hardware. In certain aspects, some or all of the components, systems, etc., may be executed on the processor of a general-purpose computer (such as the one shown as an example in FIG. 12). Furthermore, the system components may be realized either within a single computing device or spread out among several interconnected computing devices.

In one aspect, the method of the present disclosure determines an optimal logistics plan for shipping perishable goods. In order to make assessments and optimization of the logistics plan, thermal data is aggregated. For example, thermal data may be measured, collected, or gathered at various times and in various locations, such as at a source location of the perishable goods prior to the departure of the perishable goods from a shipping location, at one or more locations and/or times during shipping (e.g., on tracks) or shipment, and after arrival of the perishable goods at the recipient location or destination. Thus, the data collection may involve measuring and/or collecting temperature data by shippers, transportation facilitators, and/or as recipients. For example, if the perishable goods are steaks, a shipper may be a company selling the steaks, and the recipient may be an end consumer receiving the steaks. In another example where the perishable goods are an organ for transplant, a shipper may be a first hospital sending the organ for transplant to a second hospital, and the recipient may be the second hospital at which an operation involving the organ is to be performed. In yet another example where the perishable goods are a medication, the shipper may be a manufacturer of the medication, and the recipient may be a pharmacy that distributes the medication to consumers or, alternatively, the recipient may be an end consumer who requires the medication. Once temperature data is collected, it can be aggregated and analyzed to obtain statistical information about temperature related issues, such as thermal performance of packaging or transportation containers during shipping, and to improve predictions and operability for future shipments by optimizing future logistics plans.

In one aspect, a method of determining a logistics plan may include measuring, capturing, or generating data regarding a distribution center where a perishable good or goods should be sent from, a shipping method that should be used, a container and insulation that the perishable good or goods should be placed in, a determination of a day/date the perishable good or goods should be shipped, a type of coolant that should be included with the perishable good or goods, an amount of coolant included with the perishable good or goods during shipment or any other aspects of a logistics plan that may impact the thermal performance of a shipment of perishable goods.

In one aspect, the systems, methods, and devices described in the present disclosure perform data collection, by one or more of:
Collecting data using mobile devices of shipment recipients and temperature sensors associated with shipments of perishable goods;
Collecting data from postal services and temperature sensors associated with shipments of perishable goods; and
Collecting data using mobile devices of shipment recipients and chemical temperature indicators associated with shipments of perishable goods.

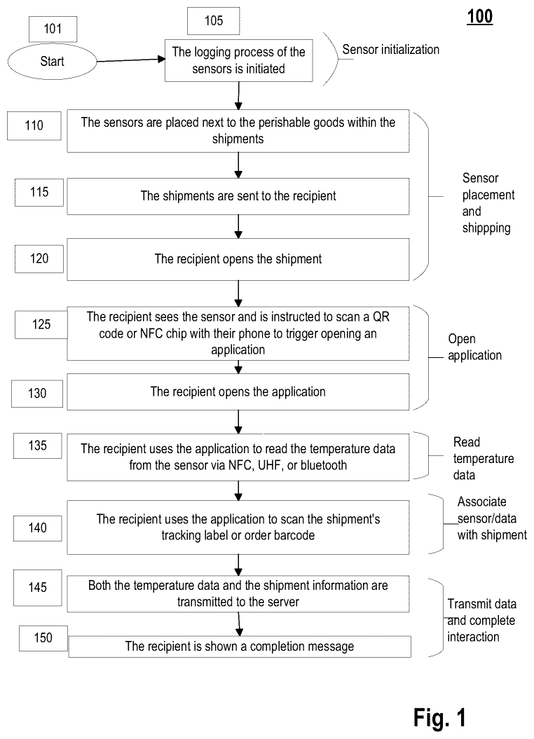

FIG. 1 illustrates a block diagram of a method 100 for collecting data using mobile devices of shipment recipients and temperature sensors associated with shipments of perishable goods in accordance with aspects of the present disclosure.

In one aspect, the sensors could be a low-cost temperature logger that consists of a small battery, power management unit, real-time clock, EEPROM storage, thermistor, NFC Antenna, NFC interface, and micro controller. With this minimal set of components, the sensor can log temperature data at a designated interval and communicate with other devices to extract the temperature data. Low cost sensors can minimize costs.

In one aspect, one or more temperature sensors periodically (e.g., every 30 minutes) sense the temperature, log the temperature data, and store the temperature data in memory. The logging interval should be determined by weighing the granularity of data needed against the storage and battery life of the sensors. For food and pharmaceuticals, every 30 minutes can be an appropriate interval. The temperature data may be read, downloaded, or otherwise retrieved from the sensors using a mobile device, such as a mobile phone. The communication between the mobile device and the sensors may be via standard protocols, such as via a Near Field Communication (NFC) connection if the devices are designed to securely exchange data based on Radio Frequency Identification (RFID), via Ultra High Frequency (UHF) connection if line-of-sight communication is possible between the devices, a Bluetooth® connection if the devices support the Bluetooth protocol for communication over short distances, or any other wireless standard.

In some aspects, sensors can communicate with other sensors, sensors can communicate with mobile devices, mobile devices can communicate with other mobile devices, and/or other communications between sensors, mobile devices, or other devices (e.g., servers, relay devices, user equipment, wearable devices, scanning devices, and/or other devices) via or using one or more wireless and/or wired networks and/or protocols. Examples include Wi-Fi, Bluetooth, 2G, 3G, 4G LTE, 5G, 6G, FlashLinQ, WiMedia, ZigBee, WLAN, sensors, and/or others. Transceivers, power management, processors, memory, cameras, scanners, displays, and/or other features, components, systems, sub-systems, and the like can be configured and/or used as appropriate to implement the various aspects described herein.

In one aspect, method 100 may be implemented on one or more computing devices such as shown in FIG. 12. In another aspect, method 100 may be implemented in a cloud network environment and may be accessed by a user via a browser software. Method 100 starts at block 101 and proceeds to block 105.

In block 105, any number of one or more sensors are initialized to gather data. The initialization of a sensor to gather data begins the logging of data, e.g., temperature data, for the sensor.

In block 110, a shipment of perishable goods is prepared, the preparation includes placing at least one of the initialized sensors next to the perishable goods within the shipment. For example, sensors may be placed next to the perishable good within a shipping container, box, etc., such that temperature in the vicinity of the perishable good can be sensed and logged periodically.

In block 115, the shipment is sent to a recipient with affixed shipment data. For example, once the preparation of the shipment is completed, a recipient address and/or any other relevant information for shipping to the recipient may be affixed to the shipment (or container), and the prepared shipment may be sent towards the recipient, via a carrier service.

In block 120, the recipient receives the shipment.

In block 125, instructions are provided to the recipient to collect data from the one or more sensors in the shipment.

In one aspect, the instructions include at least instructions for one or more of: gathering information for identifying a sensor via a mobile device of the recipient and triggering an opening of an application on the mobile device of the recipient. For example, the recipient may see the sensor and see an instruction to scan a QR code or an NFC chip using a camera or other imaging sensor of their mobile device.

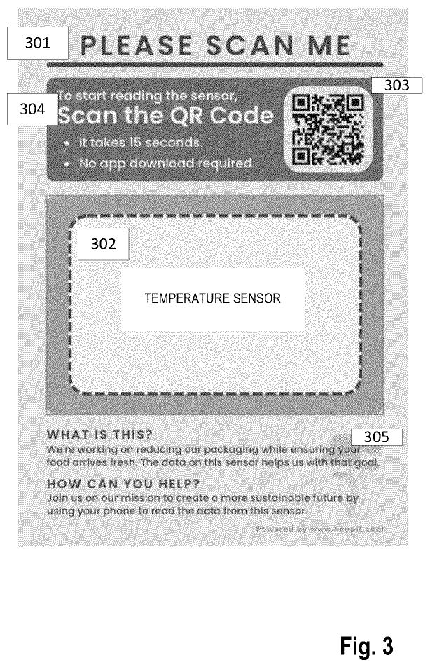

FIG. 3 illustrates an instruction 300 placed on the sensor for viewing by the recipient in accordance with the teachings of the present disclosure. For example, the instruction 300 may include the message 301 which recites “PLEASE SCAN ME”, an indication as to where the location of the temperature sensor 302, a QR code or an NFC chip 303, instructions for scanning the QR code or the NFC chip 304, any other messages 305 from the shipper, etc. In one aspect, the QR code or NFC chip 304 contains a Universal Resource Locator (URL) that maps to an application designed to enable reading sensor data. For instance, for the QR code shown in FIG. 3, when the mobile device hovers over the QR code with the camera application open, a popup may appear. The recipient taps the popup and follows the instructions presented on the screen of the mobile device.

In one aspect, in order to encourage the recipient to read the instructions and execute the blocks, one or more of the following messages 305 may be displayed to the recipient:
a message describing environmental benefits of helping the shipper reduce packaging while ensuring that the perishable goods arrive fresh to their respective destinations;
a message indicating to the recipient that the recipient is able to verify the conditions of the perishable goods by scanning the sensor;
a message indicating to the recipient that the recipient may or will receive one or more discounts on goods and/or services by scanning the sensor for data; and
a message indicating to the recipient that the recipient receives complementary services by scanning the sensor for data.

Returning to FIG. 1, in block 130, the application is opened on the mobile device of the recipient. In one aspect, the recipient may interact with the mobile device to open the application and follow the instructions.

In block 135, the sensor data is read using one or more scans and/or wireless connections and the application installed on the mobile device. For example, the application may be used to read temperature data from the sensor via a Bluetooth, UHF or NFC connection established between the mobile device of the recipient and the sensor.

In one aspect, the reading of the sensor data is performed without having the recipient download the application to the mobile device. In another aspect, the reading of the sensor data is performed by having the recipient download the application onto a mobile device of the recipient.

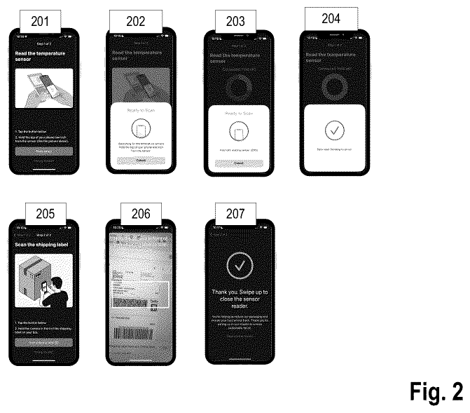

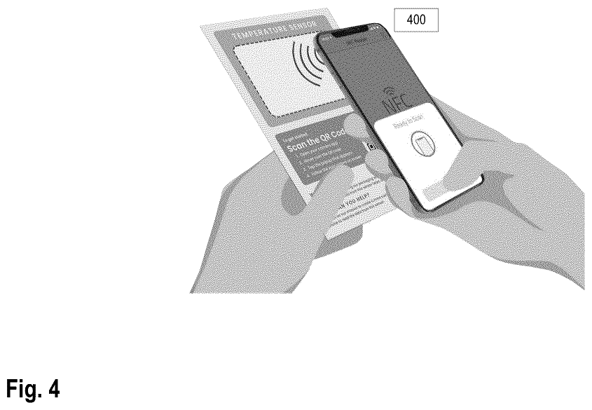

FIG. 2 illustrates views of a mobile device 200 with instructions being displayed to the recipient in accordance with the teachings of the present disclosure. For example, the recipient may read the sensor data by invoking the application from an app store (e.g., via iOS app clips, Android Instant Apps, a mobile web app, other similar means), as shown in 201. The instruction to search for a temperature sensor is displayed, as shown in 202. When the reading begins, a ready to scan message is displayed, as shown in 203. Then, the recipient holds the mobile device steady to facilitate the scanning. FIG. 4 illustrates a view 400 of the mobile device being held steady next to or otherwise in operable proximity to the sensor to facilitate the reading of the temperature data in accordance with aspects of the present disclosure. Thus, the recipient holds the mobile device next to or otherwise in operable proximity to the sensor. When the scanning is complete, an indication as to the completion of the reading and the transmission of the result to the server is displayed via a display of the mobile device, as shown in 204.

In block 140, the sensor data read in block 135 is associated with shipment data. In one aspect, the shipment data includes a tracking label or an order barcode. Thus, in one aspect, the tracking label or order barcode may be read by the application. For example, for the example of FIG. 2, instructions for scanning the shipping label are displayed, as shown in 205. Then, the recipient holds the mobile device steady, for example by hovering over the shipping label, to facilitate the scanning of the shipment data, as shown in 206. In another aspect, the recipient may type in an order number or tracking number associated with the shipment instead of scanning the shipping data.

In block 145, the sensor data and shipment data are transmitted to a server via a network. For example, both the temperature data and shipment label or barcode information may be transmitted to the server via the network.

In block 150, the recipient is notified, via a notification including at least an indication of the transmission of the sensor data and shipment data to the server and an indication as to a completion of the interaction. In addition, one or more messages may be displayed to the recipient indicating that the recipient may close the application, as shown in 207.

In one optional aspect, the messages may further include, for example, a message thanking the recipient for helping the shipper reduce packaging while ensuring the goods arrive fresh, a message indicating to the recipient whether or not the goods exceeded an appropriate temperature threshold and are/or whether the goods are safe for consumption, a message providing to the recipient a promotion code or an instruction for receiving a promotion, etc.

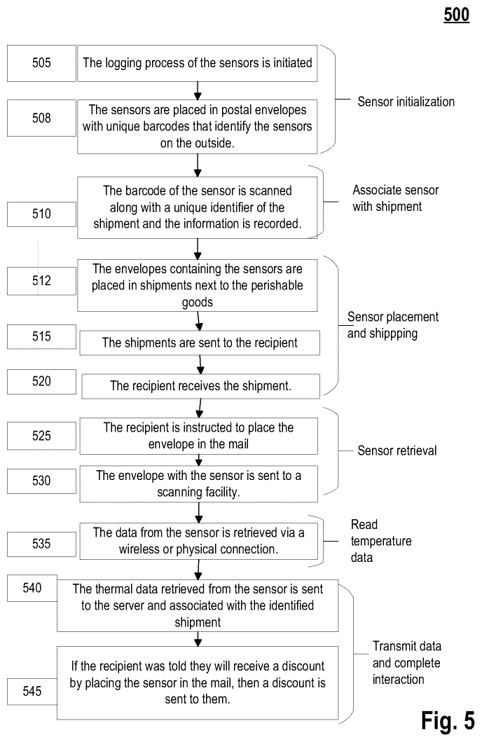

FIG. 5 illustrates a block diagram of a method 500 for collecting data from postal services and temperature sensors in accordance with aspects of the present disclosure. Generally, the sensors are placed in shipments. In addition, instructions are included instructing the recipient to mail the sensor back to its source after receiving the shipment. In one aspect, method 500 may be implemented on one or more computing devices as shown in FIG. 12. In another aspect, the method 500 may be implemented in a cloud network environment and may be accessed by a user via a browser software.

In one aspect, the temperature sensors periodically (e.g., every 30 minutes) sense the temperature, log temperature data, and store the temperature data in memory. The logging interval should be determined by weighing the granularity of data needed against the storage and battery life of the sensors. For food and pharmaceuticals, every 30 minutes can be an appropriate interval.

Typically, low-cost temperature sensors (e.g., disposable USB data logging temperature and humidity dataloggers for fruit and vegetables) are used in conjunction with this implementation. In one aspect, the sensors could be a low-cost temperature logger that consists of a small battery, power management unit, real-time clock, EEPROM storage, thermistor, USB port, USB interface, and micro controller. With this minimal set of components, the sensor can log temperature data at a designated interval and communicate with other devices to extract the temperature data.

When the sensor is received at a scanning facility, such as a postal service facility, the sensor is read to collect the temperature data for all the temperature sensing periods. The connection between the sensor and a user device of the scanning facility may be a wireless or wire-based connection.

In block 505, method 500 initializes any number of sensors to gather data. The initialization of a sensor data begins the logging of data, e.g., temperature data, for the sensor.

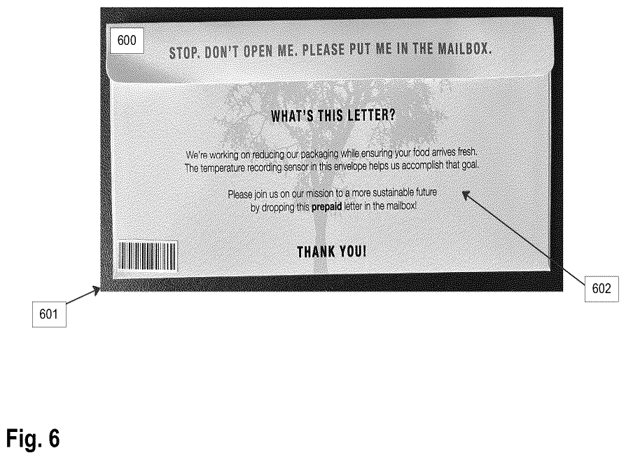

In block 508, method 500 places each sensor in an electronic discharge protective envelope and affixes a unique identifier of the sensor on the envelope. For example, a unique barcode may be used to identify each sensor contained in the envelope. FIG. 6 illustrates an envelope 600 with a barcode 601 for identifying the sensor in the envelope in accordance with aspects of the present disclosure.

In block 510, a sensor is associated with a shipment of perishable goods, the preparation by: scanning the barcode of the sensor from the envelope, scanning a unique identifier of the shipment (e.g., a shipment tracking number), associating the sensor with the shipment, and sending the associated data to a server. For example, method 500 includes sensors and shipments that are associated using the unique identifier of the sensor and the unique identifier of the shipment.

In block 512, the shipment is prepared by placing an envelope containing a uniquely identifiable sensor next to the perishable goods within the shipment. For example, after the identifiers of a sensor and a shipment are associated, the method prepares the shipment for sending by placing the envelope containing the sensor next to the perishable goods.

In block 515, the prepared shipment is sent or otherwise shipped to a recipient. For example, once the preparation of the shipment is completed, the prepared shipment may be sent towards the recipient, via a carrier service. The method then proceeds to block 520 to begin blocks for sensor retrieval, collection of temperature data.

In block 520, the recipient receives the shipment.

In block 525, instructions are provided to the recipient to send the envelope to a scanning facility. For example, the instruction may be on the outside of the envelope, as shown in 602, and the instruction may be for placing the envelope in an outgoing mailbox. The instruction may further include incentives, e.g., rewards or discounts, for following the instructions.

In block 530, the envelope is sent by the recipient, to a scanning facility. In one aspect, the envelope may be sent by a postal service or other provider.

In block 535, sensor data is collected. For example, temperature data may be read from the sensor at the scanning facility.

In block 540, the collected sensor data is transmitted to the server via a network and the server associates the sensor data with the shipment. For example, the server receives the sensor data and associates the received sensor data with the shipment based on information previously received in block 510.

In optional block 545, the recipient is sent incentives for sending the envelope to the scanning facility. For example, the recipient may have been promised a discount, a reward, etc. for placing the envelope in an outgoing mail to be sent to the scanning facility. As described above, the incentive may be displayed on the outside of the envelope, as shown in 602. Then, the method provides the reward or discount accordingly.

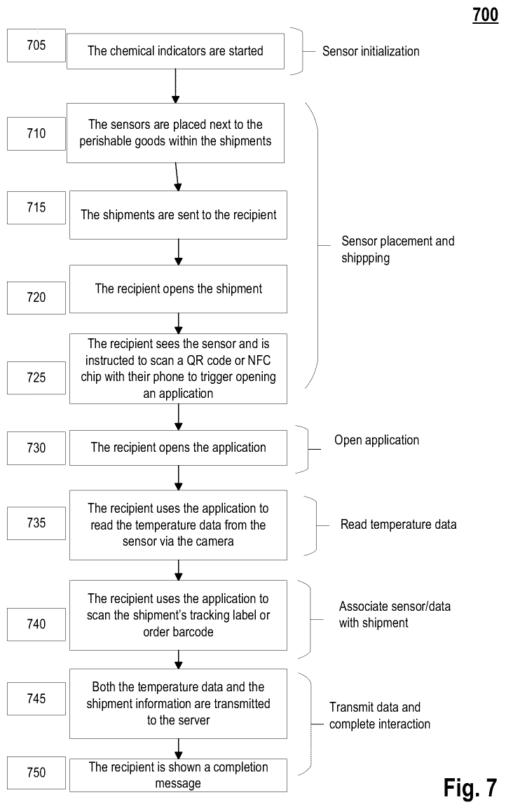

FIG. 7 illustrates a block diagram of a method 700 for collecting data using mobile devices of the recipients and chemical temperature indicators in accordance with aspects of the present disclosure. In one aspect, method 700 may be implemented on one or more computing devices such as shown in FIG. 12. In another aspect, the method 700 may be implemented in a cloud network environment and may be accessed by a user via a browser software.

In one aspect, the chemical temperature indicators are scanned by a recipient of a shipment containing perishable goods. In one aspect, information from chemical temperature indicators may be read with a camera on the mobile device of the recipient.

In one aspect, method 700 may be implemented using low-cost chemical temperature indicators that change color as they are exposed to temperatures in specific temperature ranges (e.g., cold chain indicators). In one aspect, these temperature indicators may be comprised of layers of chemicals that oxidize at different rates under different temperatures thereby changing their appearance. In another aspect, method 700 may be implemented using low-cost chemical temperature indicators that change color as they are exposed to the temperature in a specific temperature range for a pre-determined (specific) time period typically, 30-minutes to 2-hours. The specified time period is determined by the specific combination of chemicals in the layers of the indicators. In yet another aspect, a plurality of chemical temperature indicators (e.g., cold chain temperature indicators) may be used to collect information as to exposure to different ranges of temperature. In one aspect, these indicators may be comprised of different layers of chemicals that oxidize at different rates under different temperatures thereby changing their appearance when exposed to different temperatures. Thus, each of the plurality of chemical temperature indicators may change its color when exposed to a temperature of a specific range. For example, an indicator that shows the package was exposed to more than 41 degrees Fahrenheit for over 2 hours may be used along with another indicator that shows the package was exposed to more than 50 degrees Fahrenheit for more than 8 hours. By using multiple chemical temperature indicators, more granular data about the thermal performance of the shipment may be collected.

In block 705, one or more chemical temperature indicators are initialized.

In block 710, a shipment of perishable goods is prepared, the preparation including placing at least one of the initialized chemical temperature indicators next to the perishable goods within the shipment. For example, chemical temperature indicators may be placed next to the perishable good within a shipping container, box, etc., such that the chemical temperature indicator changes its color while being in the vicinity of the perishable good.

In block 715, the shipment is sent to a recipient with affixed instruction to scan a QR code or an NFC chip. For example, a recipient address and/or any other relevant information for shipping to the recipient may be affixed to the shipment (or container), and the prepared shipment may be sent towards the recipient, via a carrier service.

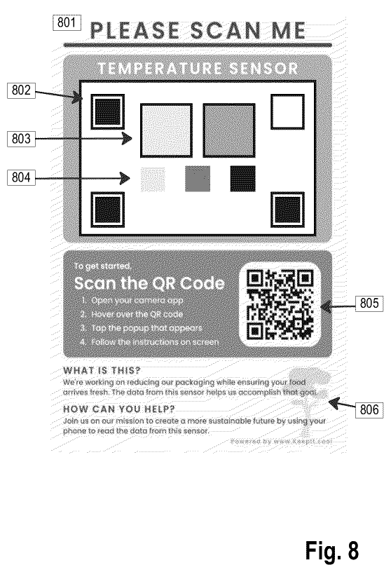

FIG. 8 illustrates an instruction 800 placed on a chemical temperature indicator for viewing by the recipient in accordance with the teachings of the present disclosure. For example, the instruction 800 may include the message 801 which recites “PLEASE SCAN ME”, an indication as to where the locations of the chemical temperature indicators are located 802, the chemical temperature indicators 803, color reference squares to aid in reading the indicators 804, a QR code or an NFC chip 805, instructions for scanning the QR code or the NFC chip 806, any other messages 807 from the shipper, etc. In one aspect, the QR code or NFC chip 805 contains a Universal Resource Locator (URL) that maps to an application designed to enable reading data of the chemical temperature indicators. For instance, for the QR code shown in FIG. 8, when the mobile device hovers over the QR code with the camera application open, a popup may appear. The recipient taps the popup and follows the instructions presented on the screen of the mobile device. In one aspect, the instruction includes at least instructions for: gathering information for triggering an opening of an application on the mobile device of the recipient. For example, the recipient may see the chemical temperature indicator and see an instruction to scan a QR code or an NFC chip with their mobile device.

In block 720, the recipient receives the shipment.

In block 725, the recipient identifies one or more chemical temperature indicators in the shipment and provides instructions to the recipient to scan the QR codes or NFC chips and to follow the instructions. As described above, the QR code or NFC chip may contain a URL that maps that invokes an application for reading data from the chemical temperature indicators.

In one aspect, in order to encourage the recipient to read the instructions and execute the blocks, one or more of the following messages 807 may be displayed to the recipient:
a message describing environmental benefits of helping the shipper reduce packaging while ensuring that the perishable goods arrive fresh to their respective destinations;
a message indicating to the recipient that the recipient is able to verify the conditions of the perishable goods by scanning the indicators;
a message indicating to the recipient that the recipient receives discounts on goods or services by scanning the indicators; and
a message indicating to the recipient that the recipient receives complementary services by scanning the indicators.

In block 730, the application is opened on the mobile device of the recipient. In one aspect, the recipient may interact with the mobile device to open the application and follow the instructions.

In one aspect, the reading of the data from the chemical temperature indicator is performed without having the recipient download the application. In another aspect, the reading of the data from the chemical temperature indicator is performed by having the recipient download the application onto a mobile device of the recipient.

In block 735, the data is read from the chemical temperature indicators using the application. In one aspect, the reading of the data from a given chemical temperature indicator comprises: initiating a camera of the mobile device of the recipient, identifying a position of the given chemical temperature indicator using image processing techniques, comparing a color of the given chemical temperature indicator with a reference color placed in the vicinity of the given chemical temperature indicator, and recording the information (e.g., taking a photo and storing in memory).

In block 740, the data of the chemical temperature indicator read in block 735 is associated with shipment data. In one aspect, the shipment data includes a tracking label or an order barcode. Thus, in one aspect, the tracking label or order barcode may be read by the application. For example, for the example of FIG. 7, instructions for scanning the shipping label may be displayed. Then, the recipient holds the mobile device steady hovering over the shipping label to facilitate the scanning of the shipment data. In another aspect, the recipient may type in the order number or tracking number instead of scanning the shipping data.

In block 745, the data is transmitted from the chemical temperature indicators and the shipment data to a server. For example, both the color data and shipment label or barcode information may be transmitted to the server.

In block 750, the recipient of the shipment is notified, where the notification including at least an indication of the transmission of the data gathered from the chemical temperature sensors and the shipment to the server and an indication as to a completion of the interaction. In addition, one or more messages may be displayed to the recipient indicating that the recipient may close the application.

In one optional aspect, the messages may further include, for example, a message thanking the recipient for helping the shipper reduce packaging while ensuring the goods arrive fresh, a message indicating to the recipient whether or not the goods exceeded the appropriate temperature threshold and are good for consumption, a message providing to the recipient a promotion code or an instruction for receiving a promotion, etc.

As described above, the present disclosure performs the data collection, from sensors by one or more of:
collecting data using mobile devices of the recipients and temperature sensors using method 100;
collecting data from postal services and temperature sensors using method 500; and
collecting data using mobile devices of the recipients and chemical temperature indicators using method 700.

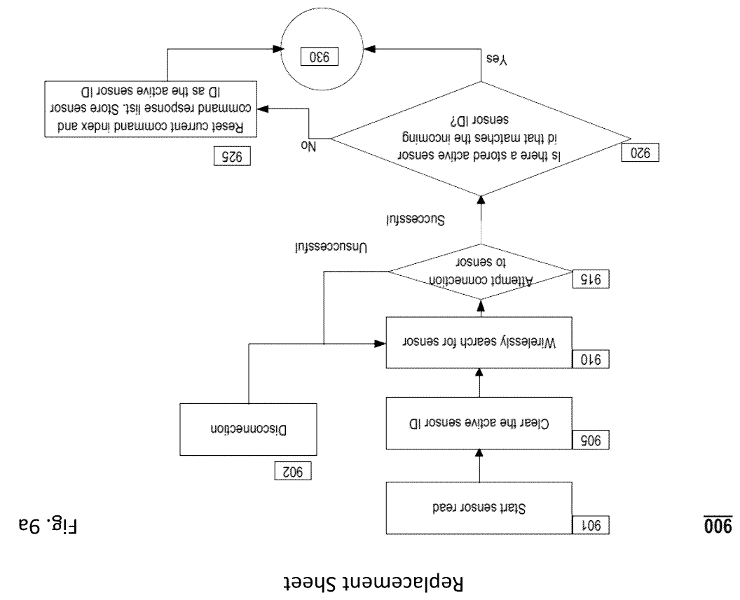

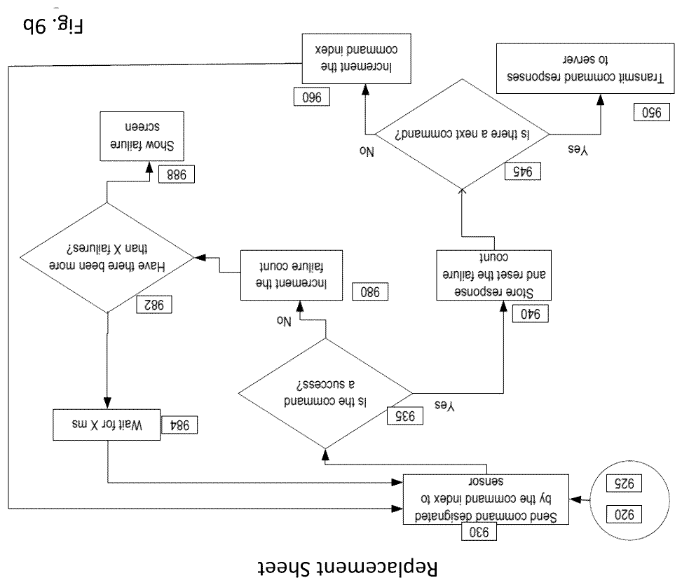

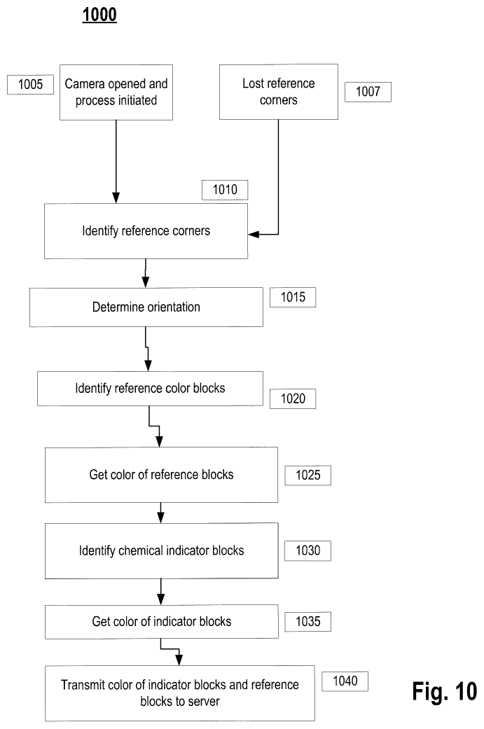

When applying method 100, 500 or 700, the speed of collecting the temperature data may vary-thereby affecting the completion rate, by the recipient, of the method. Having more data allows for a better audit of shipments and a more accurate assessment of the amount of coolant needed for a given shipment. In order to reduce the time needed to obtain accurate data and increase the accuracy of data collection, the present disclosure discloses fault tolerant methods for wirelessly reading data from electronic temperature sensors (see e.g., FIGS. 9a and 9b) and chemical temperature indicators (see e.g., FIG. 10).

FIGS. 9a and 9b illustrates a block diagram of a method 900 for collecting thermal data from electronic temperature sensors in accordance with aspects of the present disclosure. The method 900 may be implemented over a wireless connection established between a user device of a recipient of the shipment via any number and type of wireless protocols, such as NFC, UHF, Wi-Fi, Bluetooth, RFID, etc. The method 900 may be initiated by issuing sequentially sending commands to start the reading of each sensor. For example, a “start sensor read” command may be sent for a first sensor. Then, when the reading is completed for the first sensor, the command is sent to a next sensor, and so on, until all sensors are read. In order to facilitate the sequential initiation of method 900 for reading data from multiple sensors, the application keeps track of the identity of the sensor being actively read at a given time. In one example, method 900 may be implemented, as described below.

Method 900 starts in block 901 and proceeds to block 905. The execution of method 900 may begin when a user presses a button, e.g., a “read sensor” button, when a user progresses through an application to a current screen that indicates a beginning of a session, when a user opens the application, and the like.

In block 905, an active sensor ID is cleared from an application. For example, the active sensor ID in a previous period during which temperature data was collected may be present. Thus, the active sensor ID is cleared to ensure an accurate collection of sensor data. In one aspect, if there is already a process in progress and a command for reading sensors is received, the reception of the command while the process is in progress indicates that the sensor read process should be restarted. Thus, the restarting may be performed by clearing any existing information about a previous read process.

In block 910, the wireless devices search for a sensor wirelessly. In one aspect, the search for the sensor may be initiated when the mobile device becomes disconnected from the sensor at any stage of the method 900 being executed. That is, block 910 may follow block 905 or any other block of method 900 if the mobile device gets disconnected from the sensor that is being scanned. When a sensor is found, method 900 proceeds to block 915.

In block 915, the wireless device attempts to connect to the sensor. If the connection is successful, the method proceeds to block 920. Otherwise, the method returns to block 910.

In block 920, whether there is a previously stored active sensor identifier is determined, along with whether the identity of the sensor that is found matches the identity of the active sensor. When there is a previously stored active sensor and the identity of the sensor that is found matches the identity of the active sensor, method 900 proceeds to block 930. Otherwise, the method proceeds to 925.

In block 925, a command index and a command response list are each reset and stores the identity of the sensor that is found as the identity of the active sensor. Thus, the sensor that is found is now designated as the active sensor that is being read. Thus, method 900 resets any existing data stored for a previous read process. This may include command response data and the current command index being newly read. Additionally, the identity of the newly found sensor is stored as the identity of the active sensor.

In block 930, a command designated by a current command index is sent, wherein the command is selected from among a sequence of commands for reading data from memory of the active sensor, wherein a current position in the sequence of commands is designated by the current command index.

In block 935, a determination is made as to whether the command is successful. When the command is successful, method 900 proceeds to block 940. Otherwise, method 900 proceeds to block 980.

In block 940, a response to the command is stored in memory and a parameter for a failure count is reset. That is, the value of the parameter for the failure count is reset to zero.

In block 945, it is determined whether or not there is another command to be transmitted. For example, the method determines if there is a next command in the sequence of commands that is yet to be transmitted to the sensor. When there is no other command to be transmitted, the method proceeds to block 950. When there is at least one other command to be transmitted, the method proceeds to block 960.

In block 950, responses to the sequence of commands are transmitted to a server and proceeds to block 901.

In block 960, the current command index is incremented and method 900 proceeds to block 930.

In block 980, the parameter for the failure count is incremented.

In block 982, it is determined whether a value of the parameter for the failure count has exceeded a predetermined threshold for a failure count. When the value has exceeded the predetermined threshold, method 900 proceeds to block 984. Otherwise, method 900 proceeds to block 988.

In block 984, a sleep mode for the reading of the sensor is invoked for a predetermined length of time. For example, commands may not be issued for 100 milliseconds. If the predetermined length of time has elapsed, the method proceeds to block 930. Otherwise, the method remains in block 984.

In block 988, a failure screen is displayed on the mobile device of the recipient.

In one aspect, the responses from the sequence of commands may be converted into temperatures.

FIG. 10 illustrates a block diagram of a method 1000 for collecting thermal data from chemical temperature indicators in accordance with aspects of the present disclosure. An application may collect data from the chemical temperature indicators via a camera of the mobile device of the recipient. Method 1000 may begin with the application opening the camera app on the mobile device.

In block 1005, a camera on a mobile device of a recipient is opened.

In block 1010, reference corners of the chemical temperature indicator are identified using image processing techniques on an image being captured by the camera. In one aspect, the identification of the reference corners begins either when the camera is opened (i.e., following block 1005) or when the reference corners are lost (for example, if the camera is not being held in one position).

In block 1015, an orientation of a camera feed is determined, e.g., from knowledge that the upper right corner of the identified reference corners corresponds to the corner that does not have a dot in it.

In block 1020, reference color blocks are identified in the image being captured by the camera.

In block 1025, colors of the reference color blocks are sampled and recorded in memory. In one aspect, for each reference color block, the record includes all pixel values contained in the block, a median pixel value, a mean pixel value, a standard deviation of the pixel values contained in the block, and any other statistical parameter values.

In block 1030, chemical temperature indicator blocks are identified.

In block 1035, for each chemical temperature indicator block, color is determined. In one aspect, for each chemical temperature indicator block, the record includes all pixel values contained in the block, a median pixel value, a mean pixel value, a standard deviation of the pixel values contained in the block, and any other statistical parameter values.

In block 1040, the color of each chemical temperature indicator block is transmitted and each reference color block to a server, and/or determines whether the color of the chemical temperature indicator block indicates that the temperature of the block has exceeded a predetermined threshold for the block. That is, the analysis and determination of whether or not the temperature has exceeded the threshold for the block may be performed either by the mobile device or by the server.

As described above, thermal data may be collected from temperature sensors using one or more of the methods 100, 500, or 900 that result in a time series log of temperature data. In one aspect, the temperature logs of interest are the ones logged after the shipment was sent and before it was delivered. To filter the logs to the relevant set, the shipped at and delivered at timestamps can be obtained from the relevant shipping service's API using the tracking numbers or order numbers gathered in methods 100 (block 140), 500 (block 540), and 700 (block 740).

As described above, thermal data may be collected from temperature sensors or indicators using one or more of the methods 100, 500, 700, 900 or 1000. However, auditing a thermal performance of a shipment and predicting the amount of coolant needed for shipments depends not only on the sensor data but also on environmental data. Thus, the present disclosure provides a model of expected thermal behavior that is based both on sensor data collected from shipments and environmental data. In addition, the model of expected thermal behavior is improved based on feedback which is based on issues that occurred during previous shipments. Thus, the prediction of the amount of coolant required for a future shipment accounts for the knowledge gained from previous issues that occurred during shipping, environmental data, as well as data about temperatures gathered from sensors.

In one aspect, in order to collect data indicative of an exposure of the shipment to certain temperatures, data may be collected using at least a route approximation method or a sensor method.

In one aspect, collecting environmental data using the route approximation method comprises: estimating a route that the shipment took traversing from a location of the shipper to a location of the recipient using the locations and times in between these two locations gathered from shipment tracking data obtained from the relevant shipping service's API using the tracking numbers or order numbers gathered in methods 100 (block 140), 500 (block 540), and 700 (block 740) or from the shippers order management systems; further approximating the route by filling gaps between shipment tracking data using distance approximation techniques; obtaining temperature and humidity information for any number of locations and times along the approximated route; analyzing the data to generate and/or obtain a graph of temperature and/or humidity versus time. The resulting graph is indicative of the temperature and/or humidity to which the shipment is exposed while traversing the route.

In one aspect, the approximating of the route comprises the use of straight-line approximation techniques for traveling between the location of the shipper to the location of the recipient. This may be applicable, for instance, if air travel is used.

In one aspect, the approximating of the route comprises the use of road-based approximation techniques for traveling between the location of the shipper to the location of the recipient. This may be applicable, for instance, when the roadmap is known and/or GPS data is available.

In one aspect, the travel may include different types of transport, for instance, a portion of the travel may be by air and another portion may be by land. Then, the approximation of the route may include a plurality of approximation techniques, as appropriate.

In one aspect, collecting environmental data using the sensor method comprises: including another sensor (electronic or chemical) located external to an insulated area of the shipment; and collecting temperature data from the sensor located external to the insulated area of the shipment using any of the methods 100, 500, 700, 900 or 1000. Therefore, the external temperature data may be collected via a mobile device of the recipient, may be sent to a scanning facility, etc.

Once the thermal data and/or environmental data is collected, a model is built for predicting how heat is transferred from the environment to the perishable goods and ultimately, predicting or determining if the perishable goods will be spoiled upon delivery.

In one aspect, this model may be a physics-based model which has the inputs of environmental conditions and outputs of thermal performance within the packaging. The model may account for properties such as the package dimensions, insulation R-value, insulation thickness, coolant weight, coolant type, coolant thermal properties, coolant position, product weight, product type, product thermal properties, product position, or thermal conductivity between and within the products and coolant.

In one aspect, the properties input into this model such as the insulation, packaging dimensions, and/or different types and sizes of content for each shipment can be retrieved from the shipper's order management system or similar system using the tracking number or order number gathered in methods 100 (block 140), 500 (block 540), and 700 (block 740).

In one aspect, the parameters of the thermal model can be tuned using statistical techniques to ensure the output of the model aligns with the observed thermal performance collected from methods 100, 500, 700, 900 or 1000.

In one aspect, for the electronic temperature sensors, the model can be tuned by fitting the modeled temperature within the box along the journey to the actual temperature data collected from the electronic sensors. Thereby, determining the proper model parameters that best fit the collected data in aggregate.

In one aspect, for chemical temperature indicators, the model can be tuned by fitting whether or not the model predicted the temperature within the shipment would have exceeded the threshold temperature and the actual collected data of the shipments. Thereby, determining the proper model parameters that best fit the collected data in aggregate.

Then, the model may be used to predict the environmental conditions that a shipment of perishable goods with specific characteristics (e.g., size, insulation, content of shipment) may be subjected to before the content is spoiled.

In one aspect, the method of the present disclosure may be used to diagnose errors in shipment and make changes to reduce spoilage of perishable goods.

In one aspect, when using electronic temperature sensors for internal data collection, the method collects initial internal temperature of the shipment.

In one aspect, the method determines whether the perishable goods and/or the coolant are properly cooled before being shipped and whether the temperature of the content of the box exceeds the temperature of the coolant.

In one aspect, determining whether the perishable goods and/or the coolant are properly cooled before being shipped comprises: determining whether the initial internal temperature of the box exceeds an expected initial internal temperature for the contents of the box; when the initial internal temperature of the box exceeds the expected initial internal temperature, determining that the perishable goods and/or the coolant are not properly cooled before being shipped.

In one aspect, whether the temperature of the content of the box exceeds the temperature of the coolant is determined when the temperature of the sensor in the shipment begins at a first value and decreases to a second value of the temperature.

In one aspect, determining whether the insulation is performing as expected comprises:
calculating a correlation coefficient of the temperature data from the sensor inside the shipment and the ambient temperature and/or humidity; and
when the calculated correlation coefficient is above a predetermined threshold, determining that the insulation is not performing as expected.

In one aspect, the method determines whether the shipment is packed tightly. In one aspect, determining whether the shipment is packed tightly comprises: determining whether the temperature data from a sensor inside the shipment is fluctuating through the course of the shipment in a manner that is not correlated with the ambient temperature; when the fluctuation exceeds a predetermined amount, concluding that the shipment is not packed tightly, and that the sensor is moving within the shipment.

In addition, in one aspect, the present disclosure determines defects in supply chain. For example, for the collection of sensor data using the methods 100 and 700, it can be reasonably assumed that the recipient has opened the package before the timestamp when the data collection is initiated in the application. As a result, the time indicated by the timestamp may be used as an indication of when the recipient opened the package. In another example, for data collection process 100 and 500, when the internal temperature of the shipment increases significantly (for example, more than 10 degrees Fahrenheit within a 30-minute interval) after the shipment was delivered, the quick change in temperature may be used as an indication that the package has been opened. Therefore, if the time at which the shipment was opened is significantly after a time of delivery of the shipment, and the perishable goods are found to have been spoiled, the additional heat exposure during the time period between the time of delivery of the shipment and the time at which the shipment was opened may be the cause for the spoilage of the perishable goods. Thus, the collected sensor data of the present disclosure may additionally be used to reduce defects in supply chain, such as in shipping, packaging, insulating, processing at delivery, etc.

In one aspect, the method of the present disclosure may also be used to make decisions about any part of the logistics plan for a specific shipment which may include deciding the distribution center, shipping method, box size, insulation type, ship date, coolant type, or coolant amount.

In one aspect, to determine the environmental conditions expected for a specific logistics plan, a route may be predicted for the future shipment by using route data from previous similar shipments by time-shifting to the expected time of the future shipment. Then, the expected environmental exposure may be determined based on the weather forecast along the predicted route during the expected time of the shipment.

In one aspect, with these forecasted environmental conditions as model inputs, the feasibility of the logistics plan can be determined using the developed model. As described above, the thermal model developed from the collected data may be used to determine if specific environmental conditions will cause a shipment to fail-thereby causing spoilage of perishable goods. If the developed model states the perishable goods will not be spoiled, then the logistics plan is a viable option.

In one aspect, these decisions can be made by running the thermal model on a set of possible logistics plans and determining which logistics plans will result in spoiled products and which will not. And then for the successful logistics plans choosing the most desired option based on the relevant factors for the business (e.g., speed of delivery, cost of delivery, certainty of delivery, etc.).

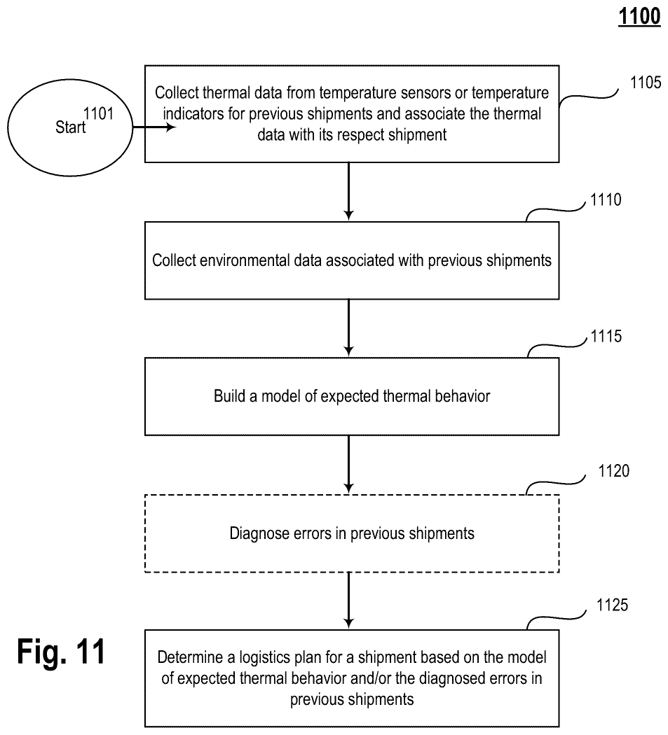

FIG. 11 illustrates a block diagram of a method 1100 for determining a logistics plan for a shipment in accordance with aspects of the present disclosure. Method 1100 starts in block 1101 and proceeds to block 1105.

In block 1105, thermal data from temperature sensors or temperature indicators is collected that is associated with previous shipments using one or more of the methods 100, 500, 700, 900 or 1000 and associates the thermal data with its respective shipment.

In block 1110, environmental data is collected that is associated with the previous shipments.

In block 1115, a model is built of expected thermal behavior that is based both on collected data from temperature sensors or temperature indicators from the previous shipments and the collected environmental data associated with the previous shipments.

In optional block 1120, errors in previous shipments are diagnosed.

In block 1125, a logistics plan for the future shipment is predicted based on the model of the expected thermal behavior and/or the errors diagnosed for previous shipments.

In one aspect, the method of the present disclosure may also be used to determine if customers have received products that are spoiled to determine if the consumer should be refunded or shipped a new product. For example, after the customer receives the shipment, the observed thermal performance collected from methods 100, 500, 700, 900 or 1000 can be made available to customer support representatives of the shipping company. If the customer is concerned about the state of the product that they received, they can contact the customer support representative. The customer support representative can check the temperature of the product at the time of delivery and, in the case of electronic temperature sensors, check the temperature of the product throughout the entire journey. The customer support representative can then make a judgement if the shipment would warrant a refund or reship based on the policies of the specific company.

In one aspect, the process stated above could be automated in an algorithmic way so the decision to reship or refund is made without the input of a customer support representative.

FIG. 12 is a block diagram illustrating various components of an example computer system 20 via which aspects of the present disclosure for determining an amount of coolant needed for shipping perishable goods may be implemented. The computer system 20 may, for example, be or include a computing system of the user device, or may comprise a separate computing device communicatively coupled to the user device, etc. In addition, the computer system 20 may be in the form of multiple computing devices, or in the form of a single computing device, including, for example, a mobile computing device, a cellular telephone, a smart phone, a desktop computer, a notebook computer, a laptop computer, a tablet computer, a server, a mainframe, an embedded device, and other forms of computing devices.

As shown in FIG. 12, the computer system 20 may include one or more central processing units (CPUs) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) may include a single or multiple sets of processors having single or multiple cores. The processor 21 may execute one or more computer-executable lines of code implementing techniques in accordance with aspects of the present disclosure. The system memory 22 may be or include any memory for storing data used herein and/or computer programs that are executable via the processor 21. The system memory 22 may include volatile memory, such as a random access memory (RAM) 25 and non-volatile memory, such as a read only memory (ROM) 24, flash memory, etc., or any combination thereof. The basic input/output system (BIOS) 26 may store the basic procedures for transfer of information among elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

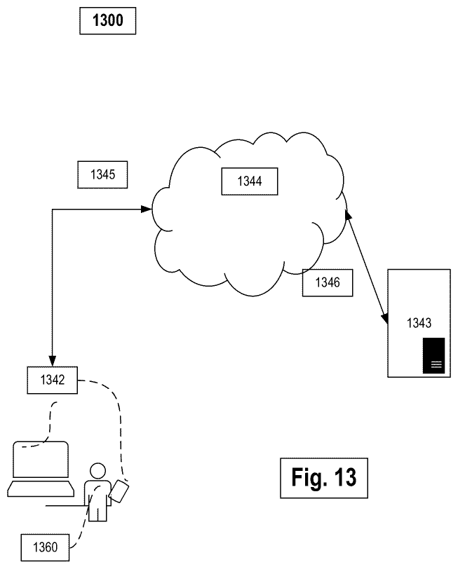

The computer system 20 may operate in a network environment as shown in FIG. 13, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

FIG. 13 shows a communication system 1300 usable in accordance with aspects of the present disclosure. The communication system 1300 includes one or more accessors 1360 (also referred to interchangeably herein as one or more “users”) and one or more terminals 1342. In one aspect, data for use in accordance with aspects of the present disclosure may, for example, be input and/or accessed by accessors 1360 via terminals 1342, such as personal computers (PCs), minicomputers, mainframe computers, microcomputers, telephonic devices, or wireless devices, such as personal digital assistants (“PDAs”), smart phones, or other hand-held wireless devices coupled to a server 1343, such as a PC, minicomputer, mainframe computer, microcomputer, or other device having a processor and a repository for data and/or connection to a repository for data, via, for example, a network 1344, such as the Internet or an intranet, and couplings 1345, 1346. In one aspect, various features of the method may be performed in accordance with a command received from another device via a coupling 1345, 1346. The couplings 1345, 1346 may include, for example, wired, wireless, or fiberoptic links. In another variation, various features of the method and system in accordance with aspects of the present disclosure may operate in a cloud network environment using Software as a Service (SaaS). For example, an internet browser running on a terminal 1342 is used to interface with a program running in hosting facility which may contain any number of servers. These servers run a cloud operating environment, which in turn executes codes of the program of the present method and system. In another variation, various features of the method and system in accordance with aspects of the present disclosure may operate in a stand-alone environment, such as on a single terminal. In one aspect, the server 1343 may be a remote computer 49 connected via a network, as shown in FIG. 12, or a local server.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 12, above). Accordingly, each module may be realized in a variety of suitable configurations and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for determining a logistics plan for a future shipment of perishable goods, comprising:
collecting thermal data from a temperature sensor or a temperature indicator captured during a previous shipment;
associating the thermal data with a respective shipment;
collecting environmental data associated with the previous shipment;
building a model of expected thermal behavior based on the collected thermal data and the collected environmental data; and
predicting an amount of coolant for the future shipment based on the model of expected thermal behavior.

2. The method of claim 1, further comprising determining at least one of an optimal distribution center, box size, insulation, ship date, shipping method, or coolant type for the future shipment based on the model of the expected thermal behavior.

3. The method of claim 1, further comprising:
diagnosing an error in the previous shipment;
analyzing the error in the previous shipment; and
further optimizing the logistics plan based on the analysis of the error in the previous shipment.

4. The method of claim 1, wherein collecting thermal data from the temperature sensor or the temperature indicator that was captured during the previous shipment further comprises:
filtering temperature logs to determine relevant temperature logs by accessing shipping data from a relevant shipping service.

5. The method of claim 1, wherein collecting environmental data associated with the previous shipment further comprises:
estimating a route of the previous shipment;
further approximating the route;
obtaining temperature or humidity information along the route; and
analyzing the environmental data and generating a graph of temperature or humidity versus time.

6. The method of claim 5, wherein estimating the route of the previous shipment further comprises approximating the route using a straight-line approximation technique.

7. The method of claim 5, wherein estimating the route of the previous shipment further comprises a road-based approximation technique.

8. The method of claim 1, wherein building the model of expected thermal behavior based on the collected thermal data and the collected environmental data further comprises building a physics-based model.

9. A system for determining an optimal logistics plan for a shipment of perishable goods, comprising:
a memory;
a processor connected to the memory and configured to:
collect thermal data from a temperature sensor or a temperature indicator from a previous shipment;
associate the thermal data with a respective shipment;
collect environmental data associated with the previous shipment;
build a model of expected thermal behavior based on both the collected data from the temperature sensor or the temperature indicator from the previous shipment and the collected environmental data associated with the previous shipment; and
determine the optimal logistics plan for the shipment based on the model of the expected thermal behavior.

10. The system of claim 9, wherein the processor is further configured to:
diagnose an error in the previous shipment; and
further determine the optimal logistics plan based on an analysis of the diagnosed error in the previous shipment.

11. The system of claim 9, wherein the processor is further configured to:
determine at least one of an optimal distribution center, box size, insulation, ship date, shipping method, or coolant type for the shipment based on the model of the expected thermal behavior.

12. The system of claim 9, wherein the processor is further configured to:
diagnose an error in the previous shipment;
analyze the error in the previous shipment; and
further optimize the logistics plan based on the analysis of the error in the previous shipment.

13. The system of claim 9, wherein the processor is further configured to filter temperature logs to determine relevant temperature logs by accessing shipping data from a relevant shipping service.

14. The system of claim 9, wherein the processor is further configured to:
estimate a route of the previous shipment;
further approximate the route;
obtain temperature or humidity information along the route; and
analyze the environmental data and generate a graph of temperature or humidity versus time.

15. The system of claim 14, wherein estimating the route of the previous shipment further comprises approximating the route using a straight-line approximation technique.

16. The system of claim 14, wherein estimating the route of the previous shipment further comprises a road-based approximation technique.

17. The system of claim 9, wherein building the model of expected thermal behavior based on the collected thermal data and the collected environmental data further comprises building a physics-based model.

18. A non-transitory computer-readable medium is provided storing a set of instructions thereon for determining an optimal logistics plan for shipping a shipment of perishable goods, wherein the set of instructions comprises instructions for:
collecting thermal data from a temperature sensor or a temperature indicator from a previous shipment;
associating the thermal data with a respective shipment;
collecting environmental data associated with the previous shipment;
building a model of expected thermal behavior based on both collected data from the temperature sensor or the temperature indicator from the previous shipment and the collected environmental data associated with the previous shipment; and
determining the optimal logistics plan for the shipment based on the model of the expected thermal behavior.

19. The non-transitory computer-readable medium of claim 18, wherein the instructions further include instructions for:
diagnosing an error in the previous shipment; and
further determining the optimal logistics plan based on an analysis of the diagnosed error in the previous shipment.

20. The non-transitory computer-readable medium of claim 18, wherein the instructions further include instructions for:
determining at least one of an optimal distribution center, box size, insulation, ship date, shipping method, or coolant type for the shipment based on the model of the expected thermal behavior.
